(19) United States
(12) Patent Application Publication
(10) Pub. No.: US 2007/0216804 A1
(43) Pub. Date: Sep. 20, 2007

(54) Picture display apparatus

(76) Inventor: Masao Kanda, Tokyo (JP)

Correspondence Address: DRINKER BIDDLE & REATH (DC), 1500 K STREET, N.W., SUITE 1100, WASHINGTON, DC, 20005-1209, US

(21) Appl. No.: 11/724,337

(22) Filed: Mar. 15, 2007

(30) Foreign Application Priority Data
Mar. 17, 2006 (JP) 2006-074343

(51) Int. Cl. H04N 3/27; H04N 5/445

(52) U.S. Cl. 348/554; 348/564

(57) ABSTRACT

A picture display apparatus having a signal processing section which performs, when a video signal is inputted to an input terminal, signal processing on the video signal inputted to the input terminal in accordance with at least one of first and second signal processing schemes, thereby outputs the video signal to display a picture corresponding to an outputted video signal of the signal processing section. When the video signal is inputted to the input terminal, notification is made to select a signal processing scheme. The signal processing section is controlled to operate in accordance with one of the first and second signal processing schemes, depending upon an input operation.

### BACKGROUND OF THE INVENTION

1. Field of the Invention

The present invention relates to a picture display apparatus capable of displaying a picture on its display in accordance with a video signal.

2. Description of the Related Art

There is a picture display apparatus arranged to receive, as input video signals, an RGB (red, green and blue) video signal (hereinafter, referred merely to as an RGB signal) and a component video signal (hereinafter, referred merely to as a component signal) at the same input terminal. The RGB signal has a positive level relative to the pedestal level, as shown in FIG. 1. The component signal is constituted with a Y (luminance) signal, a B-Y (blue color-difference) signal and an R-Y (red color-difference) signal, wherein the B-Y and R-Y signals have positive and negative levels relative to the pedestal level as shown in FIG. 2. In this manner, because there is a difference between the RGB signal and the component signal, the picture display apparatus is required to properly process the video signal inputted to the same input terminal in accordance with the type thereof.

There is a conventional picture display apparatus which automatically determines that the input video signal is either an RGB signal or a component signal and sets a signal-processing scheme in accordance with the determination result thereof. JP-A-2002-320243 discloses an apparatus that automatically determines that the input video signal is either an RGB signal or a component signal by comparing the level thereof with the pedestal level. The determination is performed by utilizing the fact that the R-Y and B-Y signals contained in the component signal have a positive level or a negative level relative to the pedestal level. In the case having a negative level relative to the pedestal level, the input video signal is determined as a component signal. JP-A-2002-21054 discloses an apparatus arranged to automatically determine that the input video signal is either an RGB signal or a component signal by detecting a synchronization frequency of the input video signal.

However, in the automatic determination method of the apparatus disclosed in JP-A-2002-320243, there are cases that the input video signal cannot be automatically determined correctly because a certain video signal, even if it is a component signal, has a level not lower than the pedestal level. Further, it is determined that the input video signal is an RGB signal when the video signal has not a level lower than the pedestal level. Accordingly, in the event of detecting a level lower than the pedestal level by including a noise component, there is a possible case to erroneously determine it as a component signal.

In the automatic determination method of the apparatus disclosed in JP-A-2002-21054, there is a difficulty in automatically determining RGB and component signals at all times without causing errors because of the existence of the RGB and component signals that are equal in synchronization frequency.

In this manner, the conventional picture display apparatus involved the difficulty in automatically determining the input video signal as RGB or component signal. Thus, there encounters a possible case that signal processing scheme is not suitably selected for the input video signal with a result that the picture is not displayed normally, which the user might determine as a failure of the apparatus.

### SUMMARY OF THE INVENTION

It is an object of the present invention to provide a picture display apparatus and a picture displaying method which are capable of selecting a suitable signal-processing scheme for a video signal inputted to the input terminal even when any type of input video signal cannot be determined automatically.

A picture display apparatus according to the present invention is a picture display apparatus comprising: a signal detecting section which detects an input of a video signal to an input terminal; a signal processing section which performs, when the signal detecting section detects an input of the video signal to the input terminal, signal processing on the video signal inputted to the input terminal in accordance with at least one of a first signal processing scheme and a second signal processing scheme different from the first signal processing scheme, and outputs a video signal processed; a display section which displays a picture in accordance with the video signal outputted from the signal processing section; a notifying section which notifies to select a signal processing scheme when the signal detecting section detects an input of the video signal to the input terminal; and a control section which controls the signal processing section to operate by one of the first and second signal processing schemes, in accordance with an input operation.

A method for displaying a picture according to the present invention comprises the steps of: detecting an input of a video signal to an input terminal; performing, when an input of the video signal to the input terminal is detected, signal processing on the video signal inputted to the input terminal in accordance with at least one of a first signal processing scheme and a second signal processing scheme different from the first signal processing scheme, and outputting a video signal processed; displaying a picture in accordance with the video signal outputted in the signal processing step; notifying to select a signal processing scheme when an input of the video signal to the input terminal is detected; and controlling the signal processing in the signal processing step to operate by one of the first and second signal processing schemes, in accordance with an input operation.

According to the invention, the display section actually displays a picture based on a video signal obtained by performing a signal processing according to the first signal processing scheme on the video signal input to the input terminal and on a video signal obtained by performing a signal processing according to the second signal processing scheme on the video signal input to the input terminal. The user is allowed to select any one of the signal processing schemes by making an operation input through viewing the picture. Therefore, a suitable signal-processing scheme can be selected so long as the video signal input to the input terminal corresponds to any one of the first and second signal processing schemes.

### BRIEF DESCRIPTION OF THE DRAWINGS

FIG. 1 is a figure showing a waveform of an RGB signal;

FIG. 2 is a figure showing a waveform of a component signal;

FIG. 3 is a figure showing a waveform of an RGB signal including a noise component;

FIG. 4 is a block diagram showing an embodiment of the present invention;

FIG. 5 is a flowchart showing the operation of a control circuit in the apparatus of FIG. 4;

FIGS. 6A and 6B are figures each showing a picture on a display;

FIG. 7 is a block diagram showing another embodiment of the invention;

FIG. 8 is a flowchart showing the operation of a control circuit in the apparatus of FIG. 7;

FIG. 9 is a figure showing a picture on a display;

FIG. 10 is a figure showing a waveform of a component signal having a ternary synchronization signal; and

FIG. 11 is a block diagram showing another embodiment of the invention.

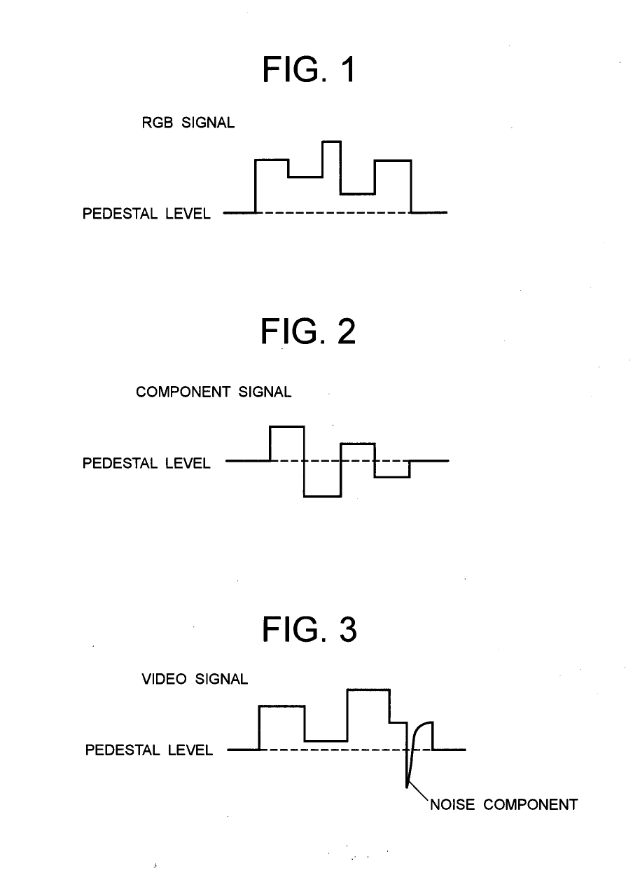

### DETAILED DESCRIPTION OF THE INVENTION

With reference to the drawings, description will now be made in detail on an embodiment according to the present invention.

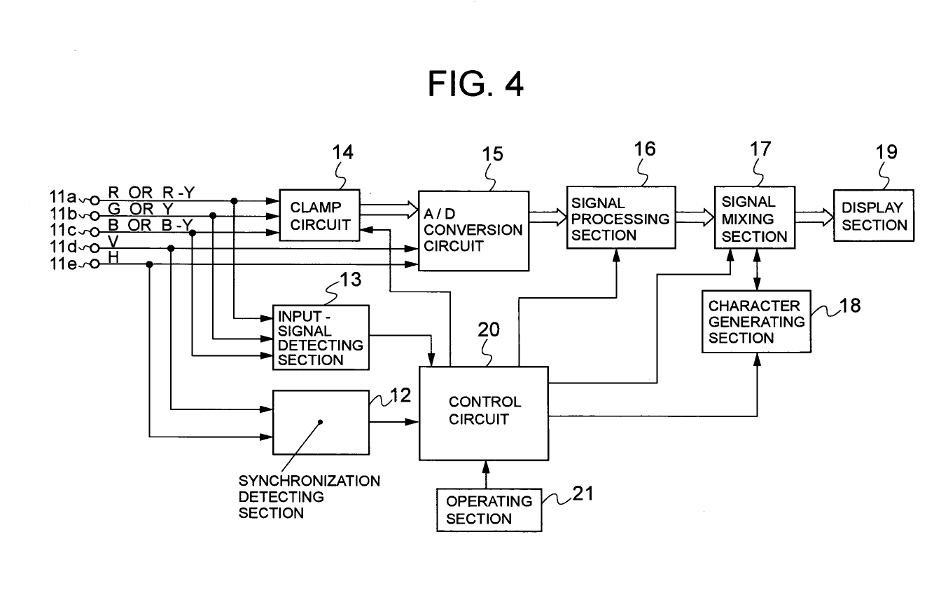

FIG. 4 shows a picture display apparatus according to the invention. The picture display apparatus includes video input terminals 11a-11e, a synchronization detecting section 12, an input-signal detecting section 13, a clamp circuit 14, an A/D conversion circuit 15, a signal processing section 16, a signal mixing section 17, a character generating section 18, a display section 19, a control circuit 20 and an operating section 21.

The video input terminals 11a-11e are made by a connector with a plurality of pins, to input an RGB signal or a component signal. The video input terminal 11a is used for both the R of RGB signal and the R-Y of component signal. The video input terminal 11b is used for both the G of RGB signal and the Y of component signal. The video input terminal 11c is used for both the B of RGB signal and the B-Y of component signal. In the case of the RGB signal, vertical and horizontal synchronization signals V, H are further added in addition to the three primary-color signals. For those synchronization signals, video input terminals 11d, 11e are employed. In the case of the component signal, the Y signal contains a synchronization signal ingredient. Meanwhile, the G of RGB signal possibly contains a synchronization signal.

The synchronization detecting section 12 detects a synchronization signal in the input video signal. When the input video signal is an RGB signal, the synchronization detecting section 12 detects vertical and horizontal synchronization signals that are respectively supplied to the video input terminals 11d, 11e. When the input video signal is a component signal or a part of an RGB signal containing a synchronization signal in the G signal, vertical and horizontal synchronization signals are extracted from the signal supplied to the video input terminal 11b.

The input-signal detecting section 13 detects supply of a video signal to the video input terminals 11a-11c. The detection depends upon a signal level at each of the video input terminals 11a-11c. The detection includes the case that a video signal currently supplied is switched into another video signal. A result of the detection by the input-signal detecting section 13 is supplied to the control circuit 20.

The clamp circuit 14 clamps the pedestal level of the input video signal to a predetermined potential, to reproduce a direct current output. The predetermined potential is different between the case the input video signal is an RGB signal and the case the input video signal is a component signal. The predetermined potential is controlled by the control circuit 20.

The A/D conversion circuit 15 digitizes the output signal of the clamp circuit 14. The signal processing section 16 performs video-signal processing, including gamma correction and resolution correction, on the digitized video signal to produce an RGB digital video signal. The signal processing section 16 performs signal processing of the video signal in accordance with a different signal processing scheme between the case of an RGB signal and the case of a component signal, under control of the control circuit 20. In the case of a component signal, the component signal is converted into an RGB signal. Furthermore, the signal processing section 16 is connected with the signal mixing section 17. The signal mixing section 17 piggybacks character data outputted from the character generating section 18, onto the output video signal of the signal processing section 16.

The display section 19 has a display, e.g. a liquid-crystal panel, a CRT or a plasma panel, so that a picture can be displayed on the display in accordance with the RGB video signal outputted from the signal processing section 16.

The control circuit 20 is configured by for example, a microcomputer, and connected to the synchronization detecting section 12, the input-signal detecting section 13, the clamp circuit 14, the signal processing section 16, the signal mixing section 17, the character generating section 18 and the operating section 21. The control circuit 20 controls the clamp circuit 14 to set the predetermined potential as a clamp level and controls the signal processing of the signal processing section 16. Furthermore, the control circuit 20 instructs the signal mixing section 17 to mix signals together and designates the character generating section 18 to generate character data. The operating section 21 has a keyboard allowing the user to make an input operation. The keyboard includes a “NEXT” key and a “ENTER” key, that are referred later. The operating section 21 may be of a remote control scheme.

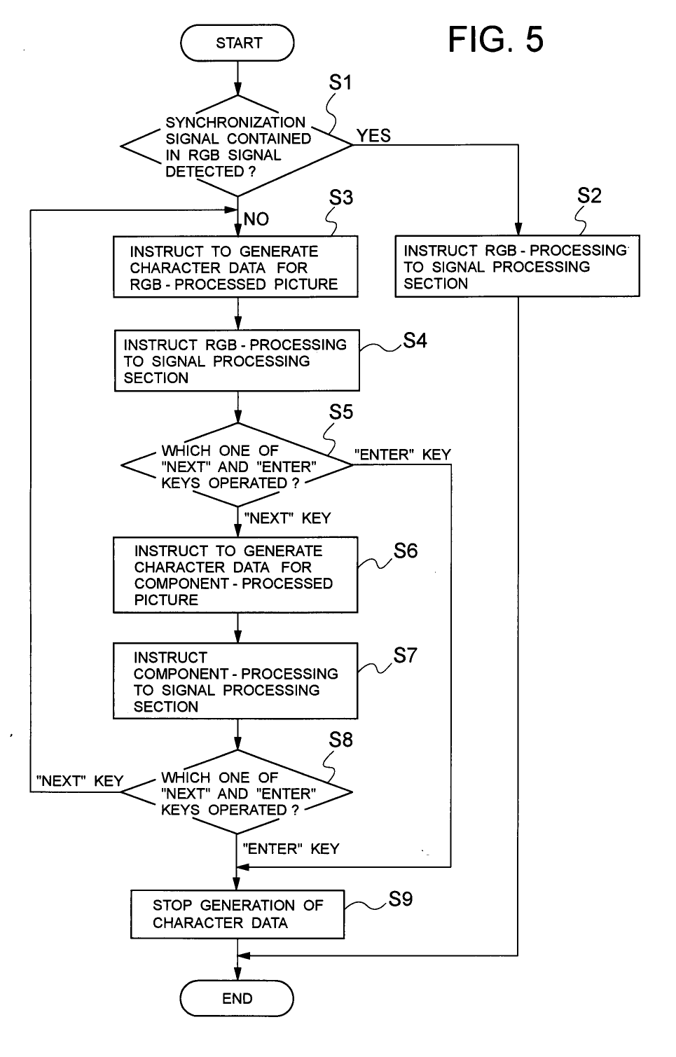

In the picture display apparatus thus configured, when one of an RGB signal and a component signal is supplied to the video input terminals 11a-11e, the one video signal is detected by the input-signal detecting section 13. The input-signal detecting section 13 supplies a detection signal, indicative of the input of the one video signal, to the control circuit 20. As shown in FIG. 5, the control circuit 20 determines whether or not the synchronization detecting section 12 detects a synchronization signal contained in the RGB signal from the signal at the video input terminals 11d and 11e, in response to the detection signal from the input-signal detecting section 13 (step S1). When the synchronization detecting section 12 detects the synchronization signal of the RGB signal, the synchronization detecting section 12 supplies a signal indicative of the detection thereof to the control circuit 20.

After detecting the input of the video signal, when the synchronization detecting section 12 detects the synchronization signal contained in the RGB signal within a predetermined time, the input video signal is determined as an RGB signal. In this case, the control circuit 20 instructs the clamp circuit 14 and signal processing section 16 to perform processing (RGB processing) corresponding to the RGB signal (step S2). Namely, the clamp circuit 14 is caused to set the predetermined potential at a potential for the RGB signal while the signal processing section 16 is caused to set video signal processing for the RGB signal. As a result, the display section 19 displays, on its display, a picture obtained by performing the RGB processing on the input video signal.

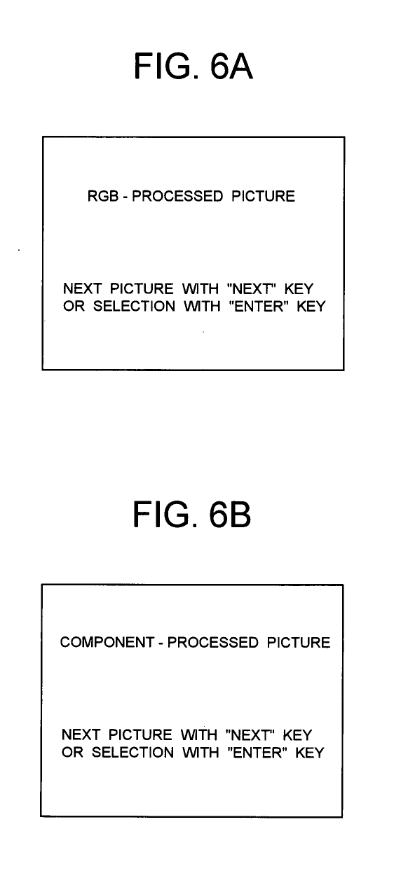

When the synchronization detecting section 12 does not detect a synchronization signal contained in the RGB signal within the predetermined time, the control section 20 instructs the character generating section 18 to generate character data for an RGB-processed picture (step S3) and instructs the clamp circuit 14 and signal processing section 16 to perform the RGB processing corresponding to the RGB signal (step S4). The character generating section 18 generates character data for an RGB-processed picture in response to the instruction of the step S3, and supplies it to the signal mixing section 17. In response to the instruction of the step S4, the clamp circuit 14 sets the predetermined potential to a potential for the RGB signal and performs a clamp operation, the signal processing section 16 performs video signal processing for the RGB signal, and the signal mixing section 17 mixes the RGB signal processed by the signal processing section 16 with the character data for the RGB-processed-picture and outputs the mixed RGB signal to the display section 19. The display section 19 displays, on the display, a picture obtained by performing the RGB processing on the input video signal, as shown in FIG. 6A. On the RGB-processed picture, a character display is made as “NEXT PICTURE WITH “NEXT” KEY, OR SELECTION WITH “ENTER” KEY” together with another character display “RGB-PROCESSED PICTURE”, by mixing the character data. Thus, the user is allowed to operate the “ENTER” key of the operating section 21 in case the picture on the display is normal, and to operate the “NEXT” key of the operating section 21 in case the picture is abnormal. Incidentally, on the display, well-defined character display may be made, e.g. “SELECT RGB SIGNAL or COMPONENT SIGNAL”.

The control circuit 20, after executing the step S4, determines which one of the “NEXT” key and the “ENTER” key has been operated (step S5). When the “NEXT” key has been operated, the character generating section 18 is instructed to generate character data for a component processed picture (step S6), while the clamp circuit 14 and signal processing section 16 are instructed to perform processing (component processing) corresponding to the component signal (step S7). The character generating section 18 generates character data for the component processed picture in response to the instruction of the step S6 and supplies it to the signal mixing section 17. In response to the instruction of the step S7, the clamp circuit 14 sets the predetermined potential at a potential for the component signal and performs a clamp operation while the signal processing section 16 performs video signal processing for the component signal. In the video signal processing for the component signal, conversion is executed to an RGB signal so that the signal mixing section 17 can mix the converted RGB signal with the character data for the component-processed picture to output the mixed RGB signal to the display section 19. The display section 19 displays, on the display, a picture obtained by performing the component processing on the input video signal, as shown in FIG. 6B. On the component-processed picture, a character display is made as “NEXT PICTURE WITH “NEXT” KEY, OR SELECTION WITH “ENTER” KEY” together with another character display “COMPONENT-PROCESSED PICTURE”, by mixing the character data.

The control circuit 20, after executing the step S7, determines which one of the “NEXT” key and the “ENTER” key has been operated (step S8). When the “NEXT” key has been operated, the step S3 is executed again. As a result, the display section 19 again displays, on the display, a picture obtained by performing the RGB processing on the input video signal, as shown in FIG. 6A.

The control circuit 20 instructs the character generating section 18 to stop the output of character data when it is determined at the step S5 or S8 that the “ENTER” key has been operated (step S9). This suspends the signal mixing section 17 from mixing character data, thus maintaining the current signal processing.

In this manner, in the picture display apparatus, when the input video signal cannot be automatically determined as an RGB signal, a picture when the input video signal has been RGB-processed and a picture when the input video signal has been component-processed are alternately displayed on the display of the display section 19 every time the “NEXT” key of the operating section 21 is operated. The RGB-processed picture includes the above one characters indicating the RGB-processed picture when being displayed, and the component-processed picture includes the above other characters indicating the component-processed picture when being displayed. The user can visually recognize easily which one of the pictures is normal, thus being allowed to select a suitable signal-processing scheme.

Incidentally, the embodiment automatically determined the input video signal as an RGB signal on the basis of the presence of a synchronization signal. Alternatively, alternate display may be provided with the FIG. 6A RGB-processed picture and the FIG. 6B component-processed picture without performing such an automatic determination every time the “NEXT” key is operated.

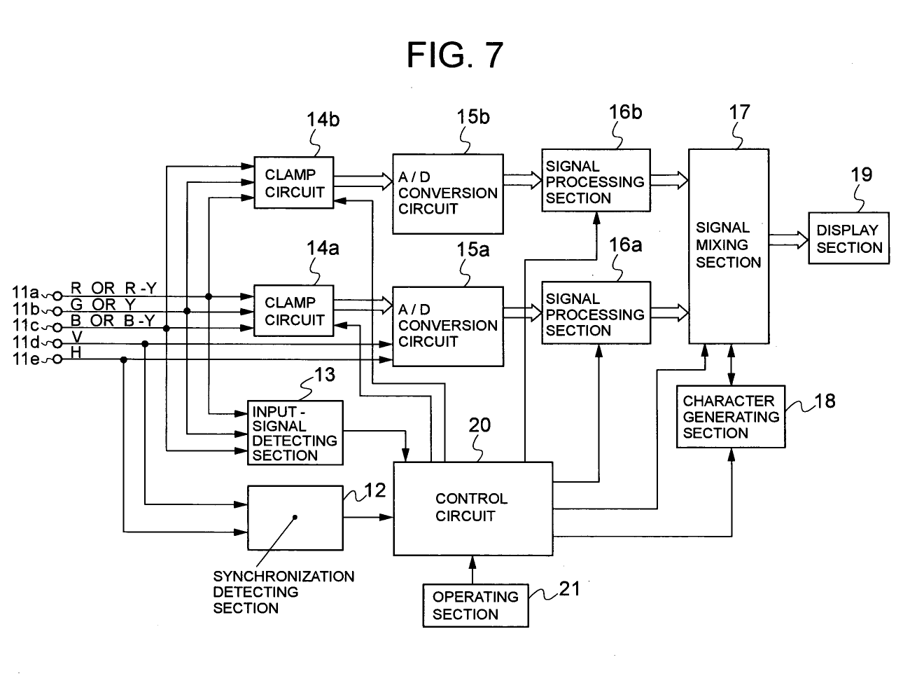

FIG. 7 shows a picture display apparatus as another embodiment of the invention. The picture display apparatus includes the clamp circuit 14, the AD conversion circuit 15 and the signal processing section 16 as shown in FIG. 4, for RGB and component processing systems. The RGB processing system is configured with a clamp circuit 14a, an A/D conversion circuit 15a and a signal processing section 16a. The clamp circuit 14a clamps the pedestal level of the input video signal to a potential for RGB processing, to reproduce a direct current output. The A/D conversion circuit 15a digitizes the output signal of the clamp circuit 14a. The signal processing section 16a performs RGB video-signal processing, including gamma correction and resolution correction, on the digitized video signal to produce an RGB digital video signal which is subjected with the RGB-signal processing.

The component processing system is configured with a clamp circuit 14b, an A/D conversion circuit 15b and a signal processing section 16b. The clamp circuit 14b clamps the pedestal level of the input video signal to a potential for component processing, to reproduce a direct current output. The A/D conversion circuit 15b digitizes the output signal of the clamp circuit 14b. The signal processing section 16b performs component-signal processing, including gamma correction and resolution correction, on the digitized video signal to produce an RGB digital video signal which is subjected with the component-signal processing.

The signal processing sections 16a, 16b are connected to a signal mixing section 17. The signal mixing section 17 outputs a mixed signal or one of the output signals of the signal processing sections 16a, 16b to the display section 19, in accordance with an instruction from the control circuit 20. The signal mixing section 17 mixes the character data outputted from a character generating section 18 with the output video signal in accordance with an instruction from the control circuit 20.

The other configuration of the picture display apparatus in FIG. 7 is similar to that of the FIG. 4 apparatus.

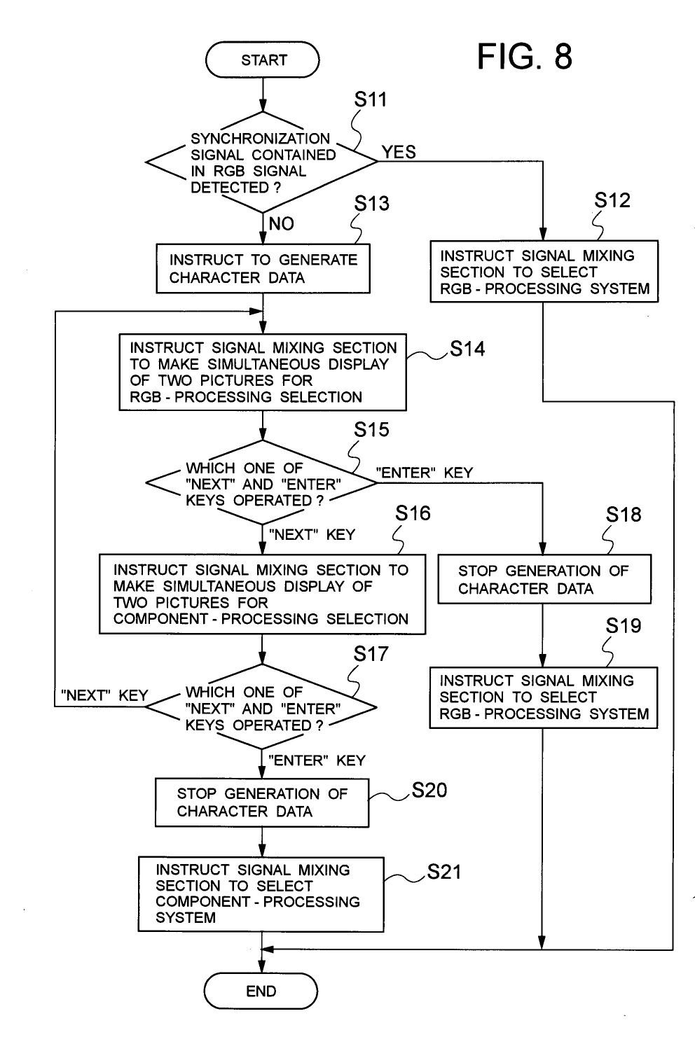

In the FIG. 7 picture display apparatus, when one video signal of the RGB and component signals is supplied to the video input terminals 11a-11e, the video signal is detected by the input-signal detecting section 13. The input-signal detecting section 13 supplies a detection signal, indicative of the input of the video signal, to the control circuit 20. As shown in FIG. 8, the control circuit 20 determines whether or not the synchronization detecting section 12 detects a synchronization signal contained in the RGB signal, in response to the detection signal from the input-signal detecting section 13 (step S11). The synchronization detecting section 12, when detected a synchronization signal contained in the RGB signal from the signal at the video-input terminals 11d, 11e, supplies a signal indicative of the detection to the control circuit 20.

After detecting the input video signal, when the synchronization detecting section 12 detects a synchronization signal contained in the RGB signal within a predetermined time, the input video signal is determined as an RGB signal. In this case, the control circuit 20 instructs the signal mixing section 17 to select the RGB processing system (step S12). Namely, the signal processing section 16a supplies an output signal to the display section 19 directly through the signal mixing section 17. As a result, the display section 19 displays, on the display, a picture obtained by performing the RGB processing on the input video signal.

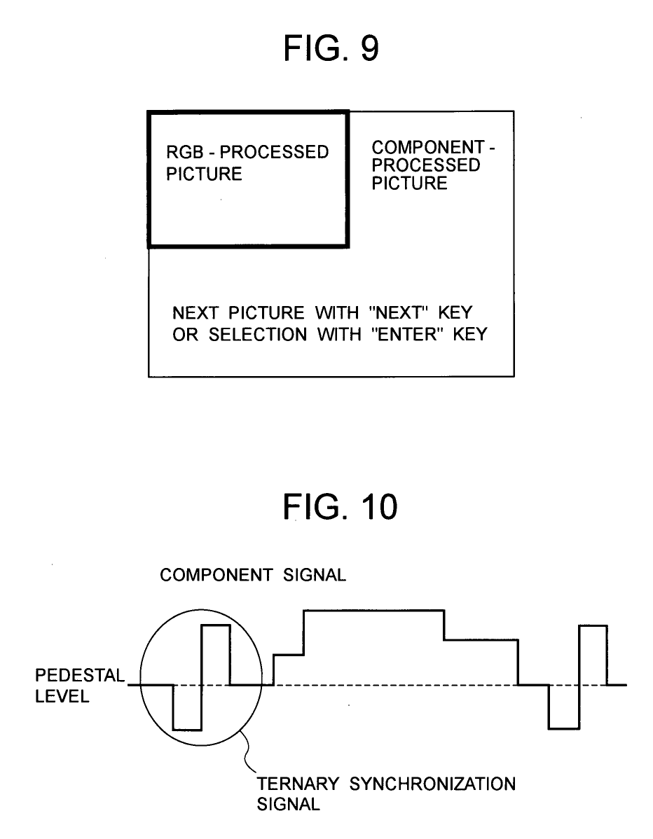

When the synchronization detecting section 12 does not detect a synchronization signal contained in the RGB signal within the predetermined time, the control circuit 20 instructs the character generating section 18 to generate character data (step S13), and instructs the signal mixing section 17 to make a simultaneous display of two pictures for RGB-processing selection (step S14). The signal mixing section 17 mixes the output signals of the signal processing sections 16a, 16b with the character data of from the character generating section 18 in response to the instruction of the two-picture simultaneous display for the RGB-processing selection, and outputs those to the display section 19. The display section 19 displays, on the display, a mixed picture of a picture obtained by performing the RGB processing on the input video signal and a picture obtained by performing the component processing on the input video signal, as shown in FIG. 9. The RGB-processed picture is shown by surrounding a bold-lined frame, within which a character display is made as “RGB-PROCESSED PICTURE” by mixing together the character data from the character generating section 18. The bold-lined frame is provided as a cursor. On the component-processed picture, “COMPONENT-PROCESSED PICTURE” is displayed with characters by mixing together the character data from the character generating section 18, and characters “NEXT PICTURE WITH “NEXT” KEY, OR SELECTION WITH “ENTER” KEY” is displayed at the same time. Thus, user is allowed to operate the “ENTER” key of the operating section 21 when the RGB-processed picture displayed on the display is normal, and to operate the “NEXT” key of the operating section 21 when the picture is abnormal.

The control circuit 20, after executing the step S14, determines which one of the “NEXT” key and the “ENTER” key has been operated (step S15). When the “NEXT” key has been operated, the signal mixing section 17 is instructed to make the two-picture simultaneous display for component-processing selection (step S16). The signal mixing section 17 mixes the output signals of the signal processing sections 16a, 16b with the character data from the character generating section 18 in response to the instruction of the two-picture simultaneous display for the component-processing selection, and outputs it to the display section 19. The display section 19 displays, on the display, a mixed picture of a picture obtained by performing the RGB processing on the input video signal and a picture obtained by performing the component processing on the input video signal. Though not shown, “RGB-PROCESSED PICTURE” is displayed with characters on the RGB-processed picture by mixing together the character data from the character generating section 18. The component-processed picture is shown by being surrounded by a bold-lined frame, within which is provided a character display of “COMPONENT-PROCESSED PICTURE” by mixing together the character data from the character generating section 18, and characters “NEXT PICTURE WITH “NEXT” KEY, OR SELECTION WITH “ENTER” KEY” is displayed at the same time. As a result, by the instruction at the step S16, the bold-lined cursor, in a position of the RGB-processed picture shown in FIG. 9, is moved onto the component-processed picture.

The control circuit 20, after executing the step S16, determines which one of the “NEXT” key and the “ENTER” key has been operated (step S17). When the “NEXT” key has been operated again, the process returns to the step S14 where the signal mixing section 17 is instructed to make the two-picture simultaneous display for the RGB-processing selection.

The control circuit 20, when determined at the step S15 that the “ENTER” key has been operated, instructs the character generating section 18 to stop the generation of the character data (step S18), and issues an instruction of the RGB picture selection to the signal mixing section 17 (step S19). On the other hand, when determined at the step S17 that the “ENTER” key has been operated, the character generating section 18 is instructed to stop the generation of the character data (step S20), and an instruction for the component picture selection is issued to the signal mixing section 17 (step S21). The signal mixing section 17 outputs only the output signal of the signal processing section 16a to the display section 19, in response to the instruction of the RGB-picture selection. The signal mixing section 17 outputs only the output signal of the signal processing section 16b to the display section 19, in response to the instruction for the component-picture selection.

In this manner, in the picture display apparatus, in the case that the input video signal cannot be automatically determined as an RGB signal, RGB-processed and component-processed pictures are simultaneously displayed as to the input video signal in one screen so that the bold-lined cursor can be moved in position between the RGB-processed picture and the component-processed picture every time the user operates the “NEXT” key of the operating section 21. Thus, the user is allowed to select a suitable signal-processing scheme because he/she can visually recognize easily which one of the pictures is normal.

Incidentally, in the embodiment, the RGB-processed and component-processed pictures are each given as a moving picture nearly based on the video signal input at that time. Alternatively, those may be provided as still pictures.

In the foregoing embodiments, in the case the automatic determination is not available as to the input video signal, RGB-processed and component-processed pictures are displayed both simultaneously or one thereof a time so for the user to select. In automatic determination, the input video signal level may be compared with a pedestal level to thereby determine it as an RGB signal or a component signal as disclosed in JP-A-2002-320243, without limited to detecting a synchronization signal contained in the RGB signal.

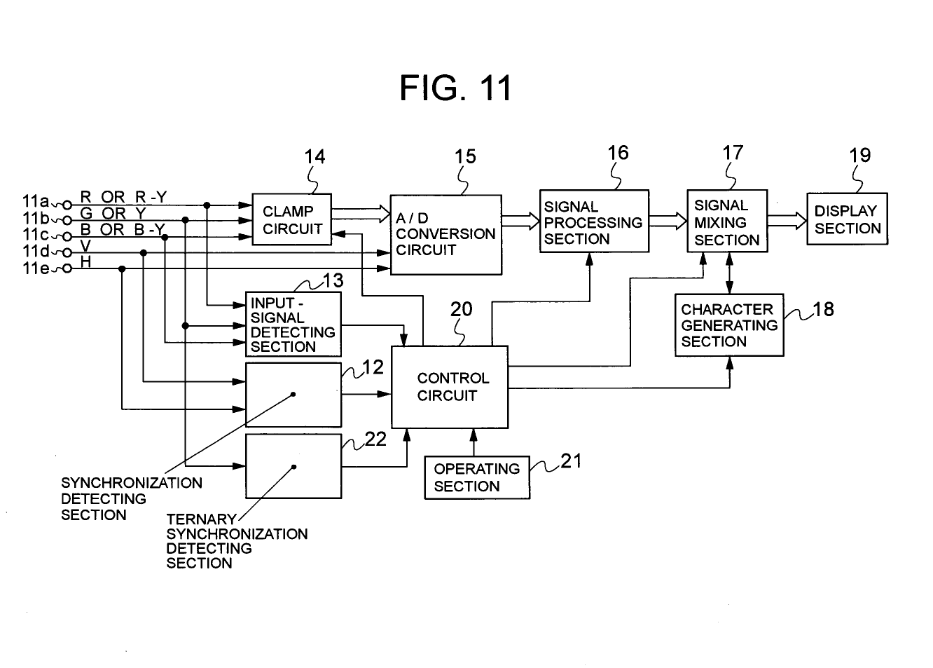

When the component signal is of a ternary synchronization signal as shown in FIG. 10, the control circuit 20 may perform automatic determination depending upon the detection result of the ternary synchronization detecting circuit 22 that detects, as the ternary synchronization signal, a time point of a change exceeding a pedestal level as shown in FIG. 11.

Further, when the automatic determination is not available by any one of or a combination of the foregoing automatic determining methods, RGB-processed and component-processed pictures may be displayed both simultaneously or one at a time for the user to select.

Although the embodiments are used with the RGB and component signal as the types of the video signals supplied to the same input terminals, the video signal types are not limited to those, i.e. other types of video signals such as a composite video signal may be input furthermore. When inputting a composite video signal, a decode circuit is provided to convert the composite video signal into an RGB or component signal. The output signal of the decode circuit may be input to the clamp circuit.

Furthermore, in the embodiments, the user is notified to select how to select picture processing by superimposing character information on the RGB-processed or component-processed picture on the display screen of the display section 19. Alternatively, such notice may be prompted by lighting or flickering a light emitter, such as LEDs, provided on the apparatus or by alert sound generated from a sound producer such as a buzzer.

As described so far, according to the invention, even in the case the video signal inputted to the input terminal cannot be automatically determined for its type, a proper scheme of signal processing can be selected for the input video signal.

This application is based on Japanese Patent Application No. 2006-074343 which is hereby incorporated by reference.

What is claimed is:

1. A picture display apparatus comprising:
a signal detecting section which detects an input of a video signal to an input terminal;
a signal processing section which performs, when the signal detecting section detects an input of the video signal to the input terminal, signal processing on the video signal inputted to the input terminal in accordance with at least one of a first signal processing scheme and a second signal processing scheme different from the first signal processing scheme, and outputs a video signal processed;
a display section which displays a picture in accordance with the video signal outputted from the signal processing section;
a notifying section which notifies to select a signal processing scheme when the signal detecting section detects an input of the video signal to the input terminal; and
a control section which controls the signal processing section to operate by one of the first and second signal processing schemes, in accordance with an input operation.

2. A picture display apparatus according to claim 1, further comprising an automatic determining section which automatically determines a type of the video signal inputted to the input terminal,
wherein the control section controls the signal processing section to operate by one of the first and second processing schemes, correspondingly to the type of the video signal automatically determined by the automatic determining section, and
the notifying section notifies to select the signal processing scheme when the automatic determining section cannot automatically determine the type of the video signal inputted to the input terminal.

3. A picture display apparatus according to claim 1, wherein, when the signal detecting section detects the input of the video signal to the input terminal, the signal processing section outputs a video signal which is a mixed signal of a first video signal obtained by performing the first signal processing scheme on the video signal inputted to the input terminal and a second video signal obtained by performing the second signal processing scheme on the inputted video signal.

4. A picture display apparatus according to claim 1, wherein the display section includes the notifying section,
the signal processing section outputs a superimposed signal with character information indicating selection of the signal processing scheme on a video signal to be outputted.

5. A picture display apparatus according to claim 1, wherein the signal processing section has a first signal processing system which performs a signal processing on the video signal inputted to the input terminal by the first signal processing scheme, a second signal processing system which performs a signal processing on the video signal inputted to the input terminal by the second signal processing scheme, and a mixing section which mixes an output video signal of the first signal processing system and an output video signal of the second signal processing system, under control of the control section.

6. A picture display apparatus according to claim 1, wherein the input terminal is an input terminal for both an RGB video signal and a component video signal, the first signal processing scheme corresponding to the RGB video signal, the second signal processing scheme corresponding to the component video signal.

7. A method for displaying a picture, comprising the steps of:
detecting an input of a video signal to an input terminal;
performing, when an input of the video signal to the input terminal is detected, signal processing on the video signal inputted to the input terminal in accordance with at least one of a first signal processing scheme and a second signal processing scheme different from the first signal processing scheme, and outputting a video signal processed;
displaying a picture in accordance with the video signal outputted in the signal processing step;
notifying to select a signal processing scheme when an input of the video signal to the input terminal is detected; and
controlling the signal processing in the signal processing step to operate by one of the first and second signal processing schemes, in accordance with an input operation.
